(19) United States
(12) Patent Application Publication
(10) Pub. No.: US 2014/0149611 A1
(43) Pub. Date: May 29, 2014

(54) CHANNEL CONDITION AWARE USB DATA DELIVERY OVER Wi-Fi WITH DIFFERENTIAL TREATMENT ON DISTINCT USB ENDPOINTS

(71) Applicant: QUALCOMM INCORPORATED, San Diego, CA (US)

(72) Inventors: Xiaolong HUANG, San Diego, CA (US); Xiaodong WANG, San Diego, CA (US); Vijayalakshmi R. RAVEENDRAN, San Diego, CA (US)

(73) Assignee: QUALCOMM INCORPORATED, San Diego, CA (US)

(21) Appl. No.: 13/745,812

(22) Filed: Jan. 20, 2013

Related U.S. Application Data
(60) Provisional application No. 61/729,993, filed on Nov. 26, 2012.

(51) Int. Cl. H04B 7/26

(52) U.S. Cl. CPC H04B 7/2612
USPC 710/33

(57) ABSTRACT

Various aspects of the present disclosure provide frameworks and related mechanisms to provide for Universal Serial Bus/Internet Protocol (USB/IP) data transfer utilizing WiGig Serial Extension (WSE). The frameworks and related mechanisms (1) adapt USB transfers to variations in wireless channel conditions by making suitable adjustments to the USB transfers, e.g., by adjusting the number of outstanding USB transfers and their sizes at the core driver level; (2) administer the admission of USB devices/endpoints based on channel condition and USB requirements by translating USB requirement parameters into 802.11 admission control parameters; and (3) manage multiple USB/IP endpoint sessions with differential treatments above IP using SCTP streams instead of TCP or UDP.

### CROSS-REFERENCE TO RELATED APPLICATIONS

This application claims priority to and the benefit of provisional patent application No. 61/729,993, titled “Channel Condition Award USB Data Delivery Over Wi-Fi with Differential Treatment on Distinct USB Endpoints” and filed in the United States Patent and Trademark Office on Nov. 26, 2012, the entire content of which is incorporated herein by reference.

### BACKGROUND

1. Technical Field

Aspects of the present disclosure relate generally to methods as well as frameworks and related mechanisms to provide for Universal Serial Bus/Internet Protocol (USB/IP) data transfer utilizing WiGig Serial Extension (WSE).

2. Background

Universal Serial Bus (USB) is a serial bus standard for attaching electronic peripheral devices to a host computing device. USB was designed to replace older serial and parallel ports on computers, since these were not standardized and called for a multitude of device drivers to be developed and maintained. Although USB was originally designed for personal computers, its popularity has prompted it also to become commonplace on video game consoles, PDAs, portable DVD players, mobile phones, and other popular electronic devices.

USB was designed to allow peripherals to be connected without the need to plug expansion cards into the computer's expansion bus and to improve plug-and-play capabilities by allowing devices to be hot-swapped, wherein devices are connected or disconnected without powering down or rebooting the computer. When a device is first connected, the host enumerates and recognizes it, and loads the device driver needed for that device. USB can connect peripherals such as mouse devices, keyboards, scanners, digital cameras, printers, external storage devices, etc., and has become the standard connection method for many of these devices.

Wireless USB data transfers are known in the art, and are known to use various different wireless air interfaces, such as ultra-wideband (UWB). The Wi-Fi Alliance is a trade association that certifies and promotes wireless LAN technology utilizing 802.11 standards. The Wi-Fi Alliance is currently investigating the introduction of a system to transport USB data over such a Wi-Fi interface.

One particular configuration that might be suitable for this purpose, promoted by the industry organization Wireless Gigabit Alliance or WiGig, is called a WiGig Serial Extension (WSE). WiGig develops standards for multi-gigabit wireless communication amongst consumer electronics, handheld devices, and personal computers and provides a wireless communication interface utilizing the unlicensed 60 GHz frequency band. The WiGig specification forms the basis for the 802.11ad standard, which is a recent amendment to the IEEE 802.11 standards. The WiGig specification defines the physical (PHY) and medium access control (MAC) layers for an architecture providing IP networking over the 60 GHz wireless channel.

Some of the standards developed by WiGig include the WiGig Bus Extension (WBE), the WiGig Serial Extension (WSE), and the WiGig Display Extension (WDE). Among these, WSE is designed to support USB data delivery over a single-hop wireless communication link between a USB Host and a USB Hub/Peripheral.

Another configuration that might be suitable is the utilization of an open source USB over IP technology, utilizing a Wi-Fi Direct interface.

However, WSE or USB/IP over Wi-Fi Direct may not provide sufficient tools to ensure acceptable USB data delivery performance over Wi-Fi. That is, variations in wireless channel conditions might make conventional USB driver software ineffective, as it does not expect, and therefore does not account for such channel variability.

Furthermore, the nature of sharing the wireless channel with multiple USB endpoint devices can create additional issues with the USB driver, for example, relating to the admission of new devices as they enter wireless range.

The USB data can have wide-ranging characteristics, making both Transmission Control Protocol (TCP) and UDP potentially unsuitable. That is, the use of TCP/IP may not provide customized data handling treatment for USB endpoints that have different data requirements, and the use of UDP/IP solutions lack efficient mechanisms to ensure USB data delivery when that data has a requirement of a very low packet loss ratio.

As the WSE specifications are relatively new, development of enhanced features continues to be a goal of many involved, for improved functionality or convenience for the users of the USB devices.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the present disclosure provide frameworks and related mechanisms to provide for USB/IP data transfer utilizing WSE.

In one aspect, the disclosure provides a method for transferring USB data over a wireless link by adapting the USB transfer to wireless link conditions. The USB data transfer may be utilized with many types of architecture, including but not limited to, a WiGig Serial Extension (WSE) architecture, a Stream Control Transmission Protocol/Internet Protocol (SCTP/IP) architecture and a User Datagram Protocol/Internet Protocol (UDP/IP) architecture.

In the method, changes in wireless channel conditions, such as interference or path loss corresponding to the wireless channel, may be determined Next, one or more characteristics of a USB data transfer may be adapted in accordance with detected changes in the wireless channel conditions and a USB transfer size or a number of USB transfers may be modified based on the detected changes in the wireless channel conditions.

Additionally, a current round trip time (RTT) of a wireless channel and a data rate available for transmission on the wireless channel may be determined. The USB transfer size or the number of outstanding USB data transfers may be increased when the data rate increases. Conversely, the USB transfer size or the number of outstanding USB data transfers may be decreased when the data rate decreases. Furthermore, The USB transfer size or the number of outstanding USB data transfers may be maintained when the data rate is stabilized.

In yet another aspect, the disclosure provides a device for transferring USB data over a wireless link by adapting the USB transfer to wireless link conditions. The device may comprise at least one processor and a USB transfer manager coupled to the at least one processor. A memory may be coupled to the at least one processor which is configured to determine changes in wireless channel conditions; adapt one or more characteristics of a USB data transfer in accordance with detected changes in the wireless channel conditions; and modify a USB transfer size or a number of USB transfers based on the detected changes in the wireless channel conditions. The at least one processor which may further be configured to determine a current round trip time (RTT) of a wireless channel; and determine a data rate available for transmission on the wireless channel.

In yet another aspect, the disclosure provides a device for transferring USB data over a wireless link by adapting the USB transfer to wireless link conditions. The device may comprise means for determining changes in wireless channel conditions; means for adapting one or more characteristics of a USB data transfer in accordance with detected changes in the wireless channel conditions; and means for modifying a USB transfer size or a number of USB transfers based on the detected changes in the wireless channel conditions. The device may further comprise means for determining a current round trip time (RTT) of a wireless channel; and means for determining a data rate available for transmission on the wireless channel.

In yet another aspect, the disclosure provides a computer program product comprising a computer-readable storage medium operable on a device configured for transferring USB data over a wireless link by adapting the USB transfer to wireless link conditions. The computer-readable storage medium may comprise instructions for causing a computer to determine changes in wireless channel conditions; adapt one or more characteristics of a USB data transfer in accordance with detected changes in the wireless channel conditions; and modify a USB transfer size or a number of USB transfers based on the detected changes in the wireless channel conditions.

In another aspect, the disclosure provides a method of transferring USB data over a wireless link by translating USB requirement parameters into 802.11 admission control parameters. First, an admission control request from a USB device may be received and one or more USB admission control parameters responsive to the admission control request may be calculated. The wireless admission control parameters correspond to 802.11 ac/n and 802.11ad protocols Next, the one or more USB admission control parameters may be translated into wireless admission control parameters which are sent to a MAC. The one or more USB admission control parameters may include one or more of a Maximum MAC service data unit (MSDU) size, data rate, a service interval, burst size, delay abound, PHY rate, surplus bandwidth allowance, Type of Services/Differentiated Services Code Point (ToS/DSCP) values, enhanced distributed channel access (EDCA) priority, contention window (CW) values, arbitration inter-frame space (AIFS) values or Transmit Opportunity (TXOP) values. Alternatively, the one or more USB admission control parameters may include one or more of an allocation period, burst size, number or excessive transmissions, transfer level overhead, number or USB transactions per transfer, packet size or service interval.

A response to the admission control request may be transmitted to the USB device triggering a Wi-Fi Serial Bus (WSB) session set up procedure for the USB device. Next, a traffic stream to transmit the USB data over the wireless link may then be configured.

In yet another aspect, the disclosure provides a device for transferring USB data over a wireless link by translating USB requirement parameters into 802.11 admission control parameters. The device may comprise at least one processor and an admission control module coupled to the at least one processor. A memory may be coupled to the at least one processor which is configured to receive an admission control request from a USB device; calculate one or more USB admission control parameters responsive to the admission control request; translate the one or more USB admission control parameters into wireless admission control parameters; send the wireless admission control parameters to a MAC; and configure a traffic stream to transmit the USB data over the wireless link. The at least one processor may be further configured to transmit a response to the admission control request to the USB device; and trigger a Wi-Fi Serial Bus (WSB) session set up procedure for the USB device.

In yet another aspect, the disclosure provides a device for transferring USB data over a wireless link by translating USB requirement parameters into 802.11 admission control parameters. The device may comprise means for receiving an admission control request from a USB device; means for calculating one or more USB admission control parameters responsive to the admission control request; means for translating the one or more USB admission control parameters into wireless admission control parameters; means for sending the wireless admission control parameters to a MAC; and means for configuring a traffic stream to transmit the USB data over the wireless link. The device may further comprise means for transmitting a response to the admission control request to the USB device; and means for triggering a Wi-Fi Serial Bus (WSB) session set up procedure for the USB device.

In yet another aspect, the disclosure provides a computer program product comprising a computer-readable storage medium operable on a device configured for transferring USB data over a wireless link by translating USB requirement parameters into 802.11 admission control parameters. The computer-readable storage medium may comprise instructions for causing a computer to receive an admission control request from a USB device; calculate one or more USB admission control parameters responsive to the admission control request; translate the one or more USB admission control parameters into wireless admission control parameters; send the wireless admission control parameters to a MAC; and configure a traffic stream to transmit the USB data over the wireless link.

In another aspect, the disclosure provides a method of transferring USB data over a wireless link by managing multiple USB/IP endpoint sessions with differential treatments above IP using SCTP streams. First, a single Stream Control Transmission Protocol (SCTP) association may be configured and a plurality of USB endpoints bundled. The bundled plurality of USB endpoints may then be transported over the single SCTP association. Each SCTP association may have multiple SCTP streams and each endpoint may use a single SCTP stream. Each SCTP association may have unique configuration parameter values for serving different USB traffic requirements. Each endpoint in the plurality of USB endpoints may have similar requirements and where a USB endpoint with a different requirement may be bundled in a different SCTP association.

According to one embodiment, the method may further comprise configuring a first SCTP association having a first requirement; and configuring a second SCTP association having a second requirement, where the second requirement is different than the first requirement.

In yet another aspect, the disclosure provides a device for transferring USB data over a wireless link by managing multiple USB/IP endpoint sessions with differential treatments above IP using SCTP streams. The device may comprise at least one processor and a communication interface coupled to the at least one processor. A memory may be coupled to the at least one processor which is configured to configure a single Stream Control Transmission Protocol (SCTP) association; bundle a plurality of USB endpoints; and transport the bundled plurality of USB endpoints over the single SCTP association. The at least one processor may be further configured to configure a first SCTP association having a first requirement; and configure a second SCTP association having a second requirement, where the second requirement is different than the first requirement.

In yet another aspect, the disclosure provides a device for transferring USB data over a wireless link by managing multiple USB/IP endpoint sessions with differential treatments above IP using SCTP streams. The device may comprise means for configuring a single Stream Control Transmission Protocol (SCTP) association; means for bundling a plurality of USB endpoints; and means for transporting the bundled plurality of USB endpoints over the single SCTP association. The device may further comprise means for configuring a first SCTP association having a first requirement; and means for configuring a second SCTP association having a second requirement, where the second requirement is different than the first requirement.

In yet another aspect, the disclosure provides a computer program product comprising a computer-readable storage medium operable on a device configured for transferring USB data over a wireless link by managing multiple USB/IP endpoint sessions with differential treatments above IP using SCTP streams. The computer-readable storage medium may comprise instructions for causing a computer to configure a single Stream Control Transmission Protocol (SCTP) association; bundle a plurality of USB endpoints; and transport the bundled plurality of USB endpoints over the single SCTP association.

These and other aspects of the disclosure will become more fully understood upon a review of the detailed description, which follows.

### BRIEF DESCRIPTION OF THE DRAWINGS

The accompanying drawings, together with the specification, illustrate exemplary embodiments of the present disclosure, and, together with the description, serve to explain the principles of the present disclosure.

FIG. 1 is a simplified block diagram illustrating a conventional USB host wired to a USB device, enabling the USB host to communicate with the USB device (or endpoint).

FIG. 2 illustrates a WSE-based layer management model.

FIG. 3 illustrates a Stream Control Transmission Protocol/Internet Protocol (SCTP/IP)-based layer management model.

FIG. 4 illustrates a User Datagram Protocol/Internet Protocol (UDP/IP)-based layer management model.

FIG. 5 is a conceptual diagram illustrating an example of a hardware implementation for an apparatus employing a processing system.

FIG. 6 is a flow chart illustrating a process for transferring USB data over a wireless link by adapting the USB transfer to wireless link conditions, according to one aspect.

FIG. 7 is a flow chart illustrating a process for transferring USB data over a wireless link by translating USB requirement parameters into 802.11 admission control parameters, according to one aspect.

FIG. 8 is a flow chart illustrating a process for transferring USB data over a wireless link by managing multiple USB/IP endpoint sessions with differential treatments above IP using SCTP streams, according to one aspect.

Elements and steps in the figures are illustrated for simplicity and clarity and have not necessarily been rendered according to any particular sequence. For example, steps that may be performed concurrently or in different order are illustrated in the figures to help to improve the understanding of various aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The word “exemplary” is used herein to mean “serving as an example, instance, or illustration.” Any implementation or embodiment described herein as “exemplary” is not necessarily to be construed as preferred or advantageous over other embodiments. Likewise, the term “embodiments” does not require that all embodiments include the discussed feature, advantage or mode of operation.

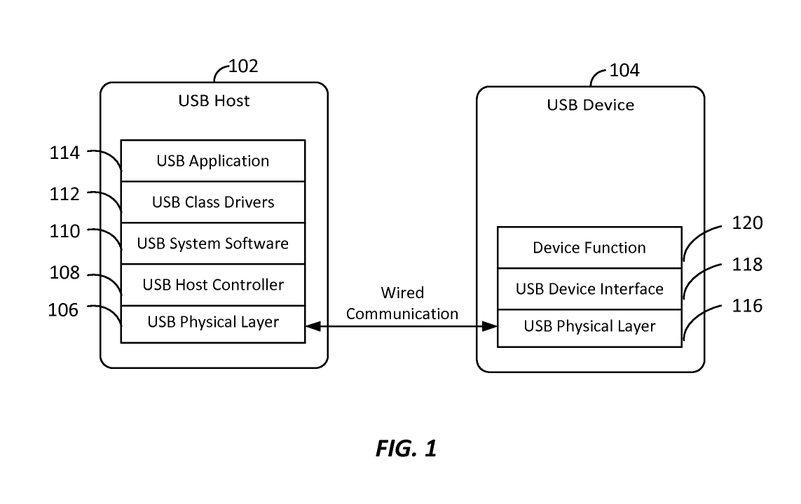

FIG. 1 is a simplified block diagram illustrating a conventional USB host 102 wired to a USB device 104, enabling the USB host 102 to communicate with the USB device 104 (or endpoint). USB limits communications between a driver and a device to four basic data transfer types (i.e., bulk, control, interrupt and isochronous) implemented as a software interface provided by the host environment. Consequently, a device must respond as expected by the system software layers or a driver will be unable to communicate with its device.

In the illustration, the USB host 102 includes a physical layer 106 for detecting the connection with a physical layer 116 of the USB device 104 and loading a corresponding USB class driver 112, and a USB host controller 108 to provide an interface for connecting the USB device 104 to the USB host 102. A USB host can have multiple host controllers and each host controller may provide one or more USB ports. System software 110 is used to interact with the USB device interface 118 on the USB device 104 and a USB application 114 establishes a channel to communicate with a USB device function 120.

### WSE-Based Layer Management Model

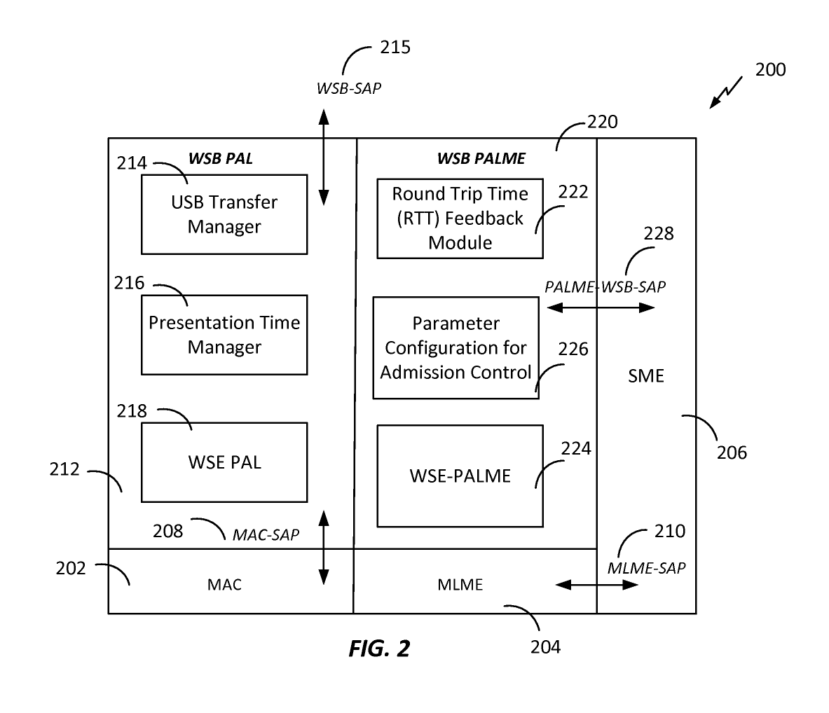

FIG. 2 illustrates a WSE-based layer management model 200. In addition to WSE protocol adaption layer (PAL) modules, Wi-Fi Serial Bus (WSB) specific modules may be included. As shown, the WSE-based layer management model 200 may include a media access control (MAC) layer 202, a MAC Sub-Layer Management Entity (MLME) 204, where the Physical layer (PHY) MAC state machines reside, and a Station Management Entity (SME) 206. The SME 206 may be a logical entity capable of communicating with all layers in the network stack—i.e., the physical (PHY) layer, the MAC layer, etc. The MLME 202 may manage the MAC layer 202 and control interactions with the SME 206.

A media access control service access point (MAC-SAP) 208 may enable the MAC layer to transmit and receive data to and from an upper layer. Also, a MAC Layer Management Entity service access point (MLME-SAP) 210 may be provided that is a service access point for a management entity in the MAC layer.

As shown, a WSB PAL module 212 may include a USB transfer manager 214 as part of the USB core driver to adapt the USB data transfer to the WSB link conditions. A WSB-SAP 215 may be provided that is a service access point for a managing entity in a protocol adaption layer. Also, a PALME-WSB-SAP 228 may be provided that is a service access point for a management entity in the WSB PALME 220.

A presentation time manager 216 may be added on top of a WSE host protocol adaption layer (PAL) 218 to configure the presentation time of the WSE PAL packet based on the USB device endpoint configuration and application performance. The WSE PAL 218 manages the WiGig protocols to enable the transfer of USB data from a host to an endpoint over a wireless channel. That is, the WSE PAL WSE functional entities implemented at the MAC and PHY layers, which generally provide a bridge between the USB protocol and a 60 GHz WiGig air interface protocol.

Additionally, a WSB Protocol Adaptation Layer Management Entity (PALME) module 220 may include a Round Trip Time (RTT) feedback module 222 added on top of a WSE Protocol Adaptation Layer Management Entity (PALME) 224 to obtain the Round Trip Time information of the WSB link. An admission control parameter configuration module 226 may be added on top of the WSE PALME 224 to correctly map the USB device endpoint configuration and application performance requirement to the MAC admission control parameters. The admission control parameter configuration module is designed to work with enhanced channel access (ECA), hybrid coordination function controlled channel access (HCCA), and 802.11ad controlled access. Also, a PALME-WSB-SAP 228 may be provided that is a service access point for a management entity in the WSB PALME 220.

SCTP/IP-Based Layer Management Model

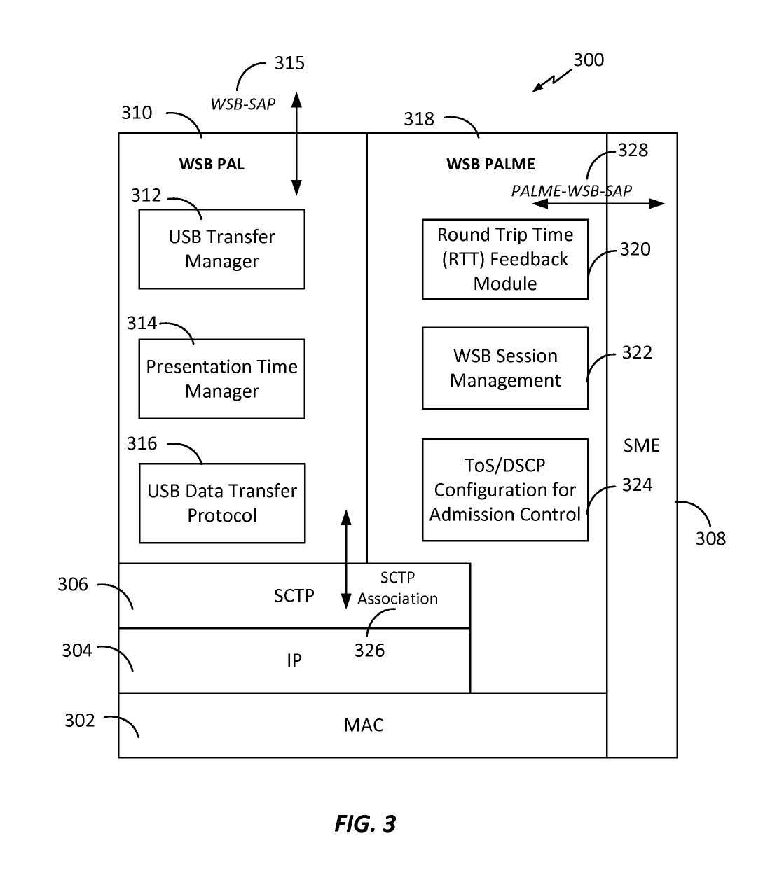

FIG. 3 illustrates a SCTP/IP-based layer management model 300. WSB specific modules are introduced on top of SCTP/IP. As shown, the SCTP/IP-based layer management model 300 may include a Media Access Control (MAC) layer 302, an Internet Protocol layer 304, a Stream Control Transmission Protocol (SCTP) layer 306 and a Station Management Entity (SME) 308. The SME 308 may be a logical entity capable of communicating with all layers in the network stack—i.e., the physical (PHY) layer, the MAC layer, etc.

As shown, a WSB PAL module 310 may include a USB transfer manager 312 as part of the USB core driver to adapt the USB data transfer to the WSB link conditions and a presentation time manager 314 on top of a USB Data Transfer Protocol module 316 to configure the presentation time of the WSE PAL packet based on the USB device endpoint configuration and application performance requirement. The USB Data Transfer Protocol module 316 may be utilized to transfer USB data at the USB core driver layer between a WSB host device and a WSB hub/peripheral device.

A WSB-SAP 315 may be provided that is a service access point for a managing entity in a protocol adaption layer. Also, a PALME-WSB-SAP 328 may be provided that is a service access point for a management entity in the WSB PALME 318.

Additionally, a WSB Protocol Adaptation Layer Management Entity (PALME) module 318 may include a Round Trip Time (RTT) feedback module 320 to manage the setup and maintenance of SCTP associations and the use of these SCTP associations for transferring USB data of USB device endpoints, a WSB session management module 322 to correctly map the USB device endpoint configuration and application performance requirement to the MAC admission control parameters. An admission control parameter configuration module 324 may be utilized to work with ECA, HCCA, and 802.11ad controlled access. The admission control parameter configuration module 324 may also be responsible for setting the proper Type of Services/Differentiated Services Code Point (ToS/DSCP) value for the IP layer.

The USB endpoints may be managed with SCTP associations 326. As described in further detail below, between two devices, there can be multiple SCTP associations where each association is a SCTP connection and each SCTP association can have its own configuration parameter values, which can serve the different USB traffic requirements.

UDP/IP-Based Layer Management Model

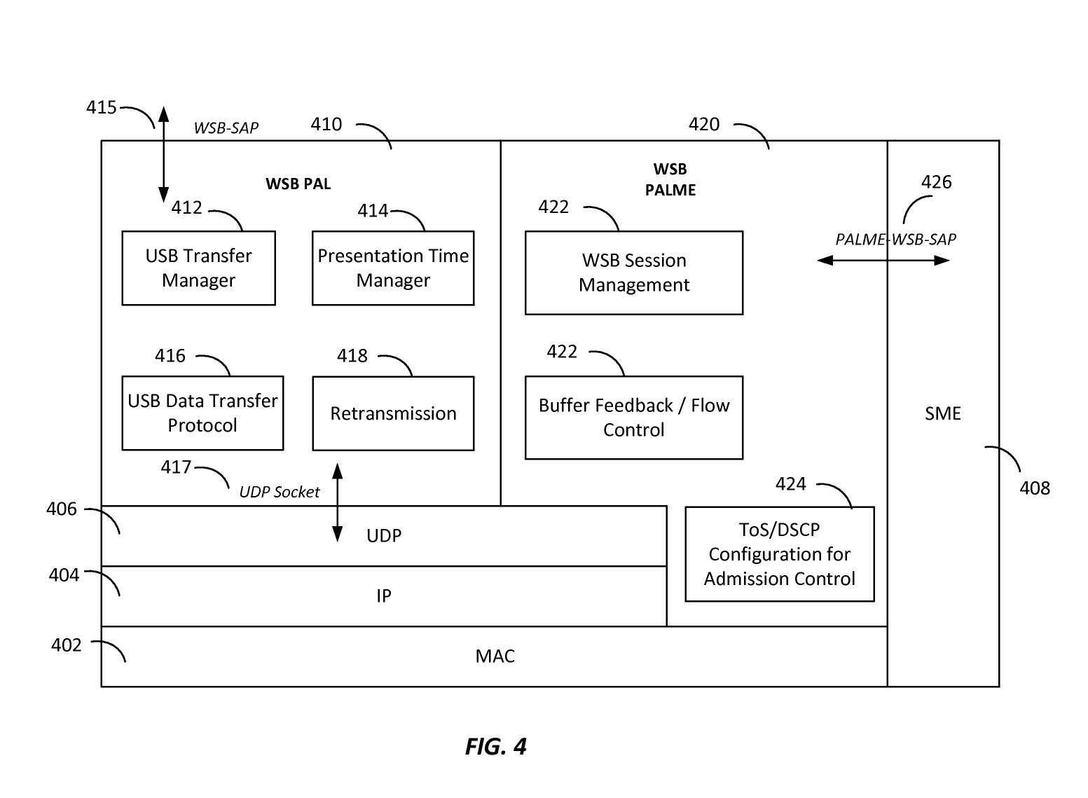

FIG. 4 illustrates a UDP/IP-based layer management model 400. As shown, the UDP/IP-based layer management model 400 may include a Media Access Control (MAC) layer 402, an Internet Protocol layer 404, a User Datagram Protocol (UDP) layer 406 and a Station Management Entity (SME) 408. The SME 408 may be a logical entity capable of communicating with all layers in the network stack—i.e., the physical (PHY) layer, the MAC layer, etc.

As shown, a WSB PAL module 410 may include a USB transfer manager 412 as part of the USB core driver to adapt the USB data transfer to the WSB link conditions and a presentation time manager 414 added on top of a USB Data Transfer Protocol module 416 to configure the presentation time of the WSE PAL packet based on the USB device endpoint configuration and application performance requirement. The USB Data Transfer Protocol module 416 may be utilized to transfer USB data at the USB core driver layer between a WSB host device and a WSB hub/peripheral device. A retransmission module 418 may be utilized to ensure the USB data is delivered to meet the performance requirement of USB applications.

A WSB-SAP 415 may be provided that is a service access point for a managing entity in a protocol adaption layer. Data may be transmitted between the MAC layer and the protocol adaption layer via a UDP socket 417.

Additionally, a WSB Protocol Adaptation Layer Management Entity (PALME) module 420 may include a WSB session management module 422 for managing the WSB streams on top of USB and the use of these WSB streams for transferring USB data of USB device endpoints. An admission control parameter configuration module 424 may be utilized to work with ECA, HCCA, and 802.11ad controlled access. The admission control parameter configuration module 424 may also be responsible for setting the proper Type of Services/Differentiated (ToS/DSCP) value for the IP layer. Also, a PALME-WSB-SAP 426 may be provided that is a service access point for a management entity in the WSB PALME 420.

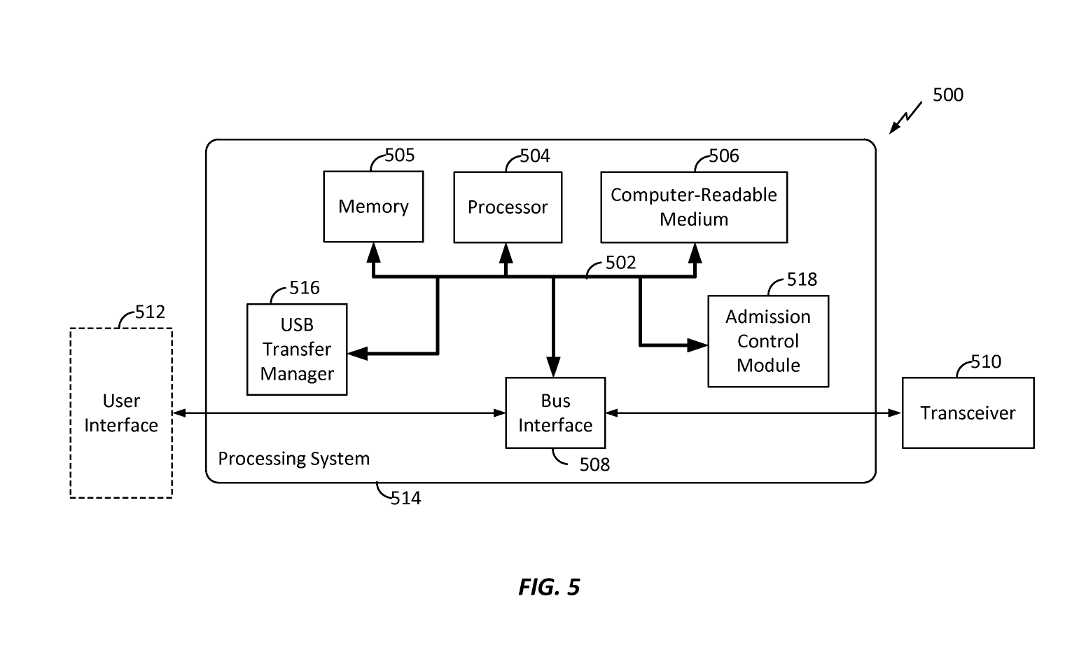

FIG. 5 is a conceptual diagram illustrating an example of a hardware implementation for an apparatus 500 employing a processing system 514. In accordance with various aspects of the disclosure, an element, or any portion of an element, or any combination of elements may be implemented with a processing system 514 that includes one or more processors 504. Examples of processors 504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 514 may be implemented with a bus architecture, represented generally by the bus 502. The bus 502 may include any number of interconnecting buses and bridges depending on the specific application of the processing system 514 and the overall design constraints. The bus 502 links together various circuits including one or more processors (represented generally by the processor 504), a memory 505, and computer-readable media (represented generally by the computer-readable medium 506). The bus 502 may also link various other circuits such as timing sources, peripherals, voltage regulators, and power management circuits, which are well known in the art, and therefore, will not be described any further. A bus interface 508 provides an interface between the bus 502 and a transceiver 510. The transceiver 510 provides a means for communicating with various other apparatus over a transmission medium. Depending upon the nature of the apparatus, a user interface 512 (e.g., keypad, display, speaker, microphone, joystick) may also be provided.

The processor 504 is responsible for managing the bus 502 and general processing, including the execution of software stored on the computer-readable medium 506. The software, when executed by the processor 504, causes the processing system 514 to perform the various functions described infra for any particular apparatus. The computer-readable medium 506 may also be used for storing data that is manipulated by the processor 504 when executing software.

One or more processors 504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 506. The computer-readable medium 506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 506 may reside in the processing system 514, external to the processing system 514, or distributed across multiple entities including the processing system 514. The computer-readable medium 506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The processing system 514 may further include a USB transfer manager 516 that adapts USB transfers to variations in wireless channel conditions by making suitable adjustments to the USB transfers, e.g., by adjusting the number of outstanding USB transfers and their sizes at the core driver level. The processing system 514 may also include an admission control module 518 to administer the admission of USB devices/endpoints based on channel condition and USB requirements by translating USB requirement parameters into 802.11 admission control parameters.

### USB Transfer Manager

As discussed above, a USB Transfer Manager may be a functional entity that acts to adapt the USB transfer to the wireless link conditions. That is, in conventional wire-line USB, data transfer size is generally fixed. However, the WSE specification does not restrict data transfer size using the wireless interface. The USB Transfer Manager may be utilized in any of the architecture described above, i.e. WSE, SCTP/IP and UDP/IP architectures.

When wireless channel conditions change, the fixed nature of the conventional USB data transfer may be inappropriate. Here, wireless channel conditions can refer to interference (e.g., generated by other devices), or path loss (e.g., varying with movement of the wireless device). To accommodate the changing wireless channel conditions, the USB Transfer Manager may adapt the USB transfer size, and/or may change the number of outstanding USB transfers, in accordance with variations in the channel conditions.

In order to determine the channel conditions, the USB Transfer Manager may utilize a “ping” transaction to determine the channel's current round trip time (RTT) and the data rate available for transmissions on that channel. Once this information about the channel conditions (e.g., RTT and data rate) is available, the USB Transfer Manager may accordingly adapt to the channel conditions. For example, when the data rate increases, the USB transfer request size or the number of outstanding USB data transfers may increase to better utilize the Wi-Fi Serial Bus (WSB) link.

In another example, when the data rate decreases, the USB transfer request size or the number of outstanding USB data transfers may decrease.

In another example, when the data rate is stabilized, the USB transfer request size or the number of USB outstanding USB data transfers should stay unchanged.

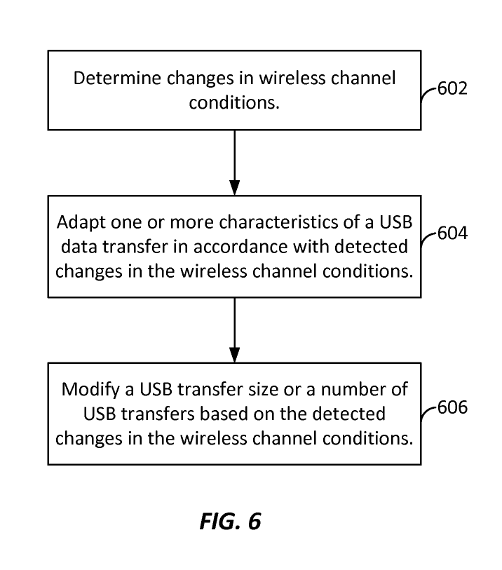

FIG. 6 is a flow chart illustrating a process for transferring USB data over a wireless link by adapting the USB transfer to wireless link conditions, according to one aspect. First, when a USB device/endpoint requests to transmit data over a wireless link, changes in wireless channel conditions may be determined 602. The wireless channel conditions may include interference or path loss corresponding to the wireless channel. As discussed above, a USB Transfer Manager may utilize a “ping” transaction to determine the channel's current round trip time (RTT) and the data rate available for transmissions on that channel. Next, one or more characteristics of a USB data transfer may be adapted in accordance with detected changes in the wireless channel conditions 604 and the USB transfer size or a number of USB transfers based on the detected changes in the wireless channel conditions may be modified 606.

### Admission Control for USB Endpoints

In a further aspect of the disclosure, the USB core driver may be enabled to assess whether a newly attached USB device/endpoint should be admitted. Currently, conventional USB devices utilize a USB endpoint admission control protocol. Using this protocol, for example, if a wire-line USB device cannot support the addition of a USB endpoint, then the admission control is supposed to reject that endpoint. However, with the utilization of a wireless channel, due to variations in channel conditions, the conventional admission control protocol is not suitable anymore. For Wi-Fi, at the MAC layer, there is already an admission control mechanism that takes current channel conditions into account.

Thus, in an aspect of the disclosure, the requirements of a USB endpoint are translated into MAC-understandable traffic parameters. One way to state this is that the USB host logic asks the Wi-Fi Serial Bus to exercise admission control based on given USB endpoint requirements. When exercising admission control, an admission control procedure may be followed. The admission control procedure may include receiving a new device/endpoint admission control request from the Station Management Entity (SME) and the WSB PALME calculating the parameters required for the underlying MAC to exercise admission control. The WSB PALME may then send the calculated values for the required parameters to the underlying MAC. Once a response is received from the MAC, based on the admission control result given by the MAC, the WSB PALME may then respond to the SME with the admission control result for the USB device/endpoint. If admitted, the SME may then trigger the WSB session setup procedure for the USB device/endpoint.

The parameters required for the underlying MAC to exercise admission control are different for 802.11ac/n and 802.11 ad.

802.11ac/n MAC Parameters

For 802.11ac/n, several parameters may be calculated and given to the underlying MAC to exercise admission control.

Firstly, the nominal MSDU size may be calculated for granted requests. The Nominal MSDU size is equal to the Number of USB transactions per transfer times the Maximum packet size plus the Transfer level overhead. The Number of USB transactions per transfer, Nₜᵣₐₙ, may be determined using equation (1) below.

$$MDR = Max \frac{\begin{matrix}Max Packet Size + \\ ( \frac{Transfer Level Overhead}{No . of USB transactions per transfer} )\end{matrix}}{Service Interval Transfer Level Throughput} \qquad ( 2 )$$

T_{d} denotes the tolerable latency at the transfer level, RTT denotes the round trip delay between the WSB host and the WSB device, and Tₚₒₗₗ denotes the USB Data Service Interval.

The Maximum MAC service data unit (MSDU) size may be calculated and equals a nominal MSDU size.

The Minimum Service Interval may be calculated and indicates a minimum polling interval (microseconds).

Maximum Service Interval may be calculated and indicate a maximum polling interval (microseconds) that is equal to the number of USB transactions per transfer times the USB data service interval.

The Mean Data Rate (MDR) may be calculated. The MDR indicates a mean data rate (bps) and is calculated using equation (2) below:

$${N}_{tran} = \frac{{T}_{d} - BTT}{2 {T}_{poll}} \qquad ( 1 )$$

Peak Data Rate (PDR) may be calculated. The PDR indicates a maximum data rate (bps) and is calculated using equation (3) below:

PDR=(Mean Data Rate×Max Burst Size)×Max No. of Burts (3)

where the Max Burst Size equals the USB Maximum burst size times the Maximum Number of Bursts.

Delay Bound may be calculated. The Delay Bound indicates a permissible delay time (microseconds) and is equal to the tolerable latency at the transfer level.

Minimum PHY Rate may be calculated. The Minimum PHY Rate indicates a minimum PHY rate (bps) and is equal to the Mean Data Rate.

Surplus Bandwidth Allowance (SBA) may be calculated. The SBA means the surplus bandwidth required during MSDU transmission and is calculated using equation (4) below:

$$SBA = 1 + \frac{No . of Excessive Transmissions}{100} \qquad ( 4 )$$

The Number of excessive transmissions, is calculated using equation (5) below:

$${p}_{drop} = {\sum }_{k = {N}_{ex}}^{{N}_{ex} + 100} ( \begin{matrix}{N}_{ex} + 100 \\ k\end{matrix} ) {{p}_{e}^{k} ( 1 - {p}_{e} )}^{{N}_{ex} + 100 - k} \qquad ( 5 )$$

Where p_{drop} denotes the probability of packet dropping that the USB endpoint can tolerate, while denotes the probability of packet error.

Type of Services/Differentiated Services Code Point (ToS/DSCP) values may be calculated. The ToS/DSCP is based on enhanced distributed channel access (EDCA) UP and is equal to the IP ToS/DSCP mapped for the voice (VO) Access Category.

With EDCA, EDCA, high-priority traffic has a higher chance of being sent than low-priority traffic: a station with high priority traffic waits a little less before it sends its packet, on average, than a station with low priority traffic. This is accomplished by using a shorter contention window (CW) and shorter arbitration inter-frame space (AIFS) for higher priority packets. The exact values depend on the physical layer that is used to transmit the data. In addition, EDCA provides contention-free access to the channel for a period called a Transmit Opportunity (TXOP). A TXOP is a bounded time interval during which a station can send as many frames as possible (as long as the duration of the transmissions does not extend beyond the maximum duration of the TXOP). If a frame is too large to be transmitted in a single TXOP, it should be fragmented into smaller frames. The use of TXOPs reduces the problem of low rate stations gaining an inordinate amount of channel time in the legacy 802.11 DCF MAC. A TXOP time interval of 0 means it is limited to a single MAC service data unit (MSDU) or MAC management protocol data unit (MMPDU). The levels of priority in EDCA are called access categories (ACs).

The CWₘᵢₙ, CWₘₐₓ, AIFS, TXOPₗᵢₘᵢₜ values may be calculated and are adjustable only under an infrastructure network, but are consistent for all traffic.

### 802.11ad MAC Parameters

For 802.11ad, the following parameters may be calculated and given to the underlying MAC to exercise admission control:

Firstly, the allocation period may be calculated. The allocation period equals the number of USB transactions per transfer times the USB data service interval where the Number of USB transactions per transfer, Nₜᵣₐₙ, may be determined using equation (6) below.

$${N}_{tran} = \frac{{T}_{d} - BTT}{2 {T}_{poll}} \qquad ( 6 )$$

T_{d} denotes the tolerable latency at the transfer level, RTT denotes the round trip delay between the WSB host and the WSB device, and Tₚₒₗₗ denotes the USB Data Service Interval.

The minimum allocation (MA) may be determined using equation (7) below.

$$MA = ( No . of USB trans . / transfer \times Max Packet size ) \cdot z 1 + \frac{No . Excessive Trans .}{100} \qquad ( 7 )$$

where “No. of USB trans./transfer” equals the Number of USB transactions per transfer, “Max Packet size” equals Maximum packet size and “No. Excessive Trans.” equals the number of excessive transmissions.

The Number of excessive transmissions, Nₑₓ, may be determined using equation (8) below.

$${p}_{drop} = {\sum }_{k = {N}_{ex}}^{{N}_{ex} + 100} ( \begin{matrix}{N}_{ex} + 100 \\ k\end{matrix} ) {{p}_{e}^{k} ( 1 - {p}_{e} )}^{{N}_{ex} + 100 - k} \qquad ( 8 )$$

Where p_{drop} is the probability of packet dropping that the USB endpoint can tolerate, while pₑ is the probability of packet error.

The maximum allocation may be calculated. The maximum allocation equals the minimum allocation times the maximum burst size times the maximum number or bursts.

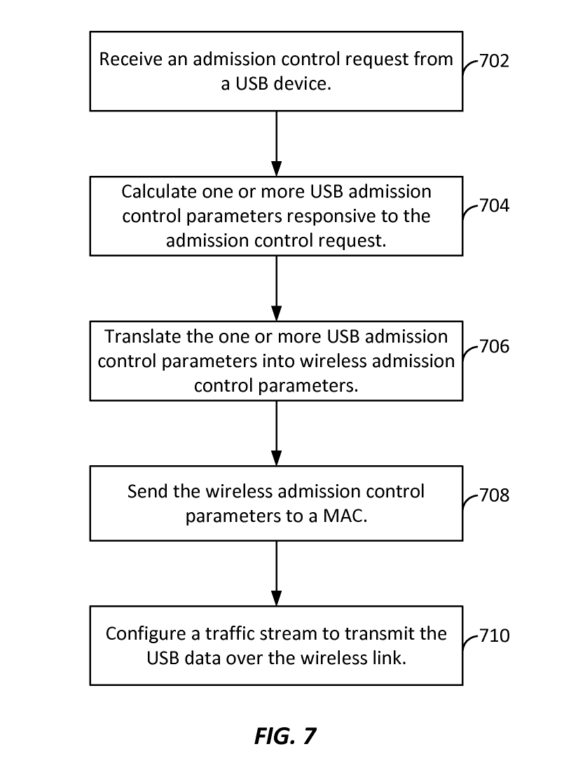

FIG. 7 is a flow chart illustrating a process for transferring USB data over a wireless link by translating USB requirement parameters into 802.11 admission control parameters, according to one aspect. First, an admission control request from a USB device may be received 702. One or more USB admission control parameters may be calculated responsive to the admission control request 704. Next, the one or more USB admission control parameters may be translated into wireless admission control parameters 706. The wireless admission control parameters may then be sent to a MAC 708 for configuring a traffic stream to transmit the USB data over the wireless link 710.

### SCTP/IP-Based WSB Functions

USB data has been known to be transported over TCP/IP technology, using open source programs. However, there are issues with this technology for USB transfers. For example, TCP is “heavy,” in terms of processing and delay. When USB transfers include real-time data, such as streaming audio and video, the overhead associated with TCP is not desired, and sometimes UDP is used instead. UDP is “lighter,” in that it does not utilize retransmissions and has reduced processing and delay relative to TCP; however, it is not as reliable as TCP.

For USB data, the requirements can vary. That is some data, such as control information, needs to be delivered reliably, but some data, such as FTP or audio/video streams do not necessarily need to be so reliable and speed is more important. Thus, an aspect of the disclosure proposes to utilize the stream control transmission protocol (SCTP) for transport layer management of USB data over a wireless communication interface.

Between two computers, there can be multiple SCTP associations. Each association is a SCTP connection. Each SCTP association can have its own configuration. This is different from TCP/IP, where all TCP/IP connections at one computer have the same configuration for most operation parameters, governed by the computers' administrator. For example, the administrator may go to the computer's registry editor to configure TCP parameters, such as how many times the computer does a retransmission before it claims the TCP connection is down; how large the TCP window size is, etc. Once those parameters are set, they are fixed for the whole computer for all TCP connections.

However, different USB connections have different requirements, and such general configuration is not desired. On the other hand, each SCTP association can take its own configuration parameter values, which can serve the different USB traffic requirements. Moreover, each SCTP connection can have multiple SCTP streams; and data transmissions on each of these multiple streams will not block each other. Thus, by bridging USB endpoint transfers with SCTP associations/streams, the varying requirements of each USB transfer can be suitably grouped such that USB transfers having one set of requirements can utilize different streams of a suitably configured SCTP association; and other USB transfers having a different set of requirements can utilize different streams of a different, suitably configured SCTP association.

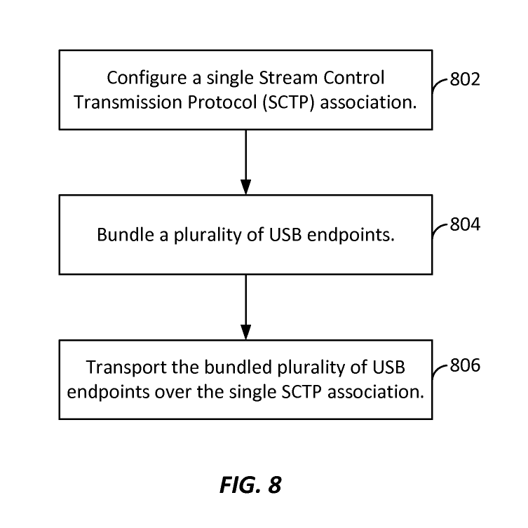

FIG. 8 is a flow chart illustrating a process for transferring USB data over a wireless link by managing multiple USB/IP endpoint sessions with differential treatments above IP using SCTP streams, according to one aspect. First, a single Stream Control Transmission Protocol (SCTP) association may be configured 802. Next, a plurality of USB endpoints may be bundled 804 and then transported over the single SCTP association 806.

According to one embodiment, each SCTP association may have multiple SCTP streams and each endpoint may use a single SCTP stream. Additionally, each SCTP association may have unique configuration parameter values for serving different USB traffic requirements and each USB endpoint in the plurality of USB endpoints may have similar requirements. A USB endpoint with a different requirement may be bundled in a different SCTP association.

According to one embodiment, the process for transferring USB data over a wireless link by managing multiple USB/IP endpoint sessions with differential treatments above IP using SCTP streams may further comprise configuring a first SCTP association having a first requirement; and configuring a second SCTP association having a second requirement, where the second requirement is different than the first requirement.

In the foregoing specification, certain representative aspects of the disclosure have been described with reference to specific examples. Various modifications and changes may be made, however, without departing from the scope of the present disclosure as set forth in the claims. The specification and figures are illustrative, rather than restrictive, and modifications are intended to be included within the scope of the present disclosure. Accordingly, the scope of the disclosure should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Furthermore, certain benefits, other advantages and solutions to problems have been described above with regard to particular embodiments; however, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present disclosure, in addition to those not specifically recited, may be varied or otherwise particularly adapted to specific environments, manufacturing specifications, design parameters, or other operating requirements without departing from the general principles of the same.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable storage medium”, “computer-readable storage medium”, and/or “processor-readable storage medium” and executed by one or more processors, machines and/or devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the disclosure described herein can be implemented in different systems without departing from the disclosure. It should be noted that the foregoing embodiments are merely examples and are not to be construed as limiting the disclosure. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method of transferring USB data over a wireless link, comprising:
determining changes in wireless channel conditions;
adapting one or more characteristics of a USB data transfer in accordance with detected changes in the wireless channel conditions; and
modifying a USB transfer size or a number of USB transfers based on the detected changes in the wireless channel conditions.

2. The method of claim 1, further comprising:
determining a current round trip time (RTT) of a wireless channel; and
determining a data rate available for transmission on the wireless channel.

3. The method of claim 2, further comprising:
increasing the USB transfer size or the number of outstanding USB data transfers when the data rate increases.

4. The method of claim 2, further comprising:
decreasing the USB transfer size or the number of outstanding USB data transfers when the data rate decreases.

5. The method of claim 1, further comprising:
maintaining the USB transfer size or the number of outstanding USB data transfers when the data rate is stabilized.

6. The method of claim 1, wherein the wireless channel conditions comprise one or more of interference or path loss corresponding to the wireless channel.

7. The method of claim 1, wherein the USB data transfer is utilized with at least one of a WiGig Serial Extension (WSE) architecture, a Stream Control Transmission Protocol/Internet Protocol (SCTP/IP) architecture and a User Datagram Protocol/Internet Protocol (UDP/IP) architecture.

8. A method of transferring USB data over a wireless link, comprising:
receiving an admission control request from a USB device;
calculating one or more USB admission control parameters responsive to the admission control request;
translating the one or more USB admission control parameters into wireless admission control parameters;
sending the wireless admission control parameters to a MAC; and
configuring a traffic stream to transmit the USB data over the wireless link.

9. The method of claim 8, wherein the wireless admission control parameters correspond to 802.11 ac/n and 802.11ad protocols.

10. The method of claim 8, wherein the one or more USB admission control parameters comprise one or more of a Maximum MAC service data unit (MSDU) size, data rate, a service interval, burst size, delay abound, PHY rate, surplus bandwidth allowance, Type of Services/Differentiated Services Code Point (ToS/DSCP) values, enhanced distributed channel access (EDCA) priority, contention window (CW) values, arbitration inter-frame space (AIFS) values or Transmit Opportunity (TXOP) values.

11. The method of claim 8, wherein the one or more USB admission control parameters comprise one or more of an allocation period, burst size, number or excessive transmissions, transfer level overhead, number or USB transactions per transfer, packet size or service interval.

12. The method of claim 8, further comprising:
transmitting a response to the admission control request to the USB device; and
triggering a Wi-Fi Serial Bus (WSB) session set up procedure for the USB device.

13. A method of transferring USB data over a wireless link, comprising:
configuring a single Stream Control Transmission Protocol (SCTP) association;
bundling a plurality of USB endpoints; and
transporting the bundled plurality of USB endpoints over the single SCTP association.

14. The method of claim 13, wherein each SCTP association has multiple SCTP streams; and wherein each endpoint uses a single SCTP stream.

15. The method of claim 13, wherein each SCTP association has unique configuration parameter values for serving different USB traffic requirements.

16. The method of claim 13, wherein each USB endpoint in the plurality of USB endpoints have similar requirements.

17. The method of claim 16, wherein a USB endpoint with a different requirement is bundled in a different SCTP association.

18. The method of claim 13, further comprising:
configuring a first SCTP association having a first requirement; and
configuring a second SCTP association having a second requirement, where the second requirement is different than the first requirement.

19. A device for transferring USB data over a wireless link, comprising:
means for determining changes in wireless channel conditions;
means for adapting one or more characteristics of a USB data transfer in accordance with detected changes in the wireless channel conditions; and
means for modifying a USB transfer size or a number of USB transfers based on the detected changes in the wireless channel conditions.

20. The device of claim 19, further comprising:
means for determining a current round trip time (RTT) of a wireless channel; and
means for determining a data rate available for transmission on the wireless channel.

21. A device for transferring USB data over a wireless link, comprising:
means for receiving an admission control request from a USB device;
means for calculating one or more USB admission control parameters responsive to the admission control request;
means for translating the one or more USB admission control parameters into wireless admission control parameters;
means for sending the wireless admission control parameters to a MAC; and
means for configuring a traffic stream to transmit the USB data over the wireless link.

22. The device of claim 21, further comprising:
means for transmitting a response to the admission control request to the USB device; and
means for triggering a Wi-Fi Serial Bus (WSB) session set up procedure for the USB device.

23. A device for transferring USB data over a wireless link, comprising:
means for configuring a single Stream Control Transmission Protocol (SCTP) association;
means for bundling a plurality of USB endpoints; and
means for transporting the bundled plurality of USB endpoints over the single SCTP association.

24. The device of claim 23, further comprising:
means for configuring a first SCTP association having a first requirement; and
means for configuring a second SCTP association having a second requirement, where the second requirement is different than the first requirement.

25. A device for transferring USB data over a wireless link, comprising:
at least one processor;
a USB transfer manager coupled to the at least one processor; and
a memory coupled to the at least one processor, wherein the at least one processor is configured to:
determine changes in wireless channel conditions;
adapt one or more characteristics of a USB data transfer in accordance with detected changes in the wireless channel conditions; and
modify a USB transfer size or a number of USB transfers based on the detected changes in the wireless channel conditions.

26. The device of claim 25, wherein the at least one processor is further configured to:
determine a current round trip time (RTT) of a wireless channel; and
determine a data rate available for transmission on the wireless channel.

27. A device for transferring USB data over a wireless link, comprising:
at least one processor;
an admission control module coupled to the at least one processor; and
a memory coupled to the at least one processor, wherein the at least one processor is configured to:
receive an admission control request from a USB device;
calculate one or more USB admission control parameters responsive to the admission control request;
translate the one or more USB admission control parameters into wireless admission control parameters;
send the wireless admission control parameters to a MAC; and
configure a traffic stream to transmit the USB data over the wireless link.

28. The device of claim 27, wherein the at least one processor is further configured to:
transmit a response to the admission control request to the USB device; and
trigger a Wi-Fi Serial Bus (WSB) session set up procedure for the USB device.

29. A device for transferring USB data over a wireless link, comprising:
at least one processor;
a communication interface coupled to the at least one processor; and
a memory coupled to the at least one processor, wherein the at least one processor is configured to:
configure a single Stream Control Transmission Protocol (SCTP) association;
bundle a plurality of USB endpoints; and
transport the bundled plurality of USB endpoints over the single SCTP association.

30. The device of claim 29, wherein the at least one processor is further configured to:
configure a first SCTP association having a first requirement; and
configure a second SCTP association having a second requirement, where the second requirement is different than the first requirement.

31. A computer program product, comprising:
a computer-readable storage medium operable on a device configured for transferring USB data over a wireless link, comprising instructions for causing a computer to:
determine changes in wireless channel conditions;
adapt one or more characteristics of a USB data transfer in accordance with detected changes in the wireless channel conditions; and
modify a USB transfer size or a number of USB transfers based on the detected changes in the wireless channel conditions.

32. A computer program product, comprising:
a computer-readable storage medium operable on a device configured for transferring USB data over a wireless link, comprising instructions for causing a computer to:
receive an admission control request from a USB device;
calculate one or more USB admission control parameters responsive to the admission control request;
translate the one or more USB admission control parameters into wireless admission control parameters;
send the wireless admission control parameters to a MAC; and
configure a traffic stream to transmit the USB data over the wireless link.

33. A computer program product, comprising:
a computer-readable storage medium operable on a device configured for transferring USB data over a wireless link, comprising instructions for causing a computer to:
configure a single Stream Control Transmission Protocol (SCTP) association;
bundle a plurality of USB endpoints; and
transport the bundled plurality of USB endpoints over the single SCTP association.
